(19) United States
(12) Patent Application Publication
(10) Pub. No.: US 2017/0147652 A1
(43) Pub. Date: May 25, 2017

(54) SEARCH SERVERS, END DEVICES, AND SEARCH METHODS FOR USE IN A DISTRIBUTED NETWORK

(71) Applicant: Institute For Information Industry, Taipei (TW)

(72) Inventors: Yen-Hung KUO, Taipei City (TW); Jun-Kai WU, Tainan City (TW); Yun-Chih LUO, Miaoli City (TW)

(21) Appl. No.: 14/946,755

(22) Filed: Nov. 19, 2015

(51) Int. Cl. G06F 17/30

(52) U.S. Cl. CPC G06F 17/30528; G06F 17/3053; G06F 17/30289

(57) ABSTRACT

Search servers, end devices, and search methods are provided. A search server includes a global index database and a processing unit. The processing unit executes a message queue service conforming to an asynchronous communication protocol. The message queue service receives a query comprising a keyword, determines that the global index database has no global search result corresponding to the keyword, distributes the keyword to a plurality of end devices in the distributed network, receives a plurality of local search results from at least a portion of the end devices, generates a global search result for the keyword according to the local search results, and stores the global search result in the global index database.

### FIELD

The present invention relates to search servers, end devices, and search methods for use in a distributed network. More particularly, the present invention relates to search servers, end devices, and search methods that search documents, discover domain experts, and discover keyword trends in a distributed network.

### BACKGROUND

Searching documents and discovering domain experts have always been a difficult task for distributed networks (e.g. enterprise networks). Conventionally, an enterprise adopts some software tool to analyze documents stored in a repository database of an enterprise network and create full-text search indices for these documents. Once key documents are determined, people related to these key documents are able to be treated as domain experts of the contents of these key documents. This conventional approach has several drawbacks. First, analyzing documents in a repository database and creating full-text search indices for these documents consume huge amount of time. Second, the created full-text search indices require tremendous space to be stored. Third, in most enterprise networks, only small portion of the full-text search indices are utilized and these small portion of the full-text search indices are utilized repeatedly. Fourth, in most enterprise networks, only relatively few documents are stored in a repository database of an enterprise network and the rest documents are stored in other spaces (e.g. employees' computers) of the enterprise network. Fifth, the relationships between people and document searched results are neither available in the repository database nor in the full-text search indices.

According to the above descriptions, a technique, without the aforementioned drawbacks, for searching documents and discovering domain expert in a distributed network is still in the need.

### SUMMARY

The disclosure includes a search server for use in a distributed network. The search server comprises a global index database and a processing unit, wherein the processing unit is electrically connected to the global index database. The processing unit is configured to execute a message queue service conforming to an asynchronous communication protocol. The message queue service receives a query comprising a keyword, determines that the global index database has no global search result corresponding to the keyword, distributes the keyword to a plurality of end devices in the distributed network, receives a plurality of first local search results from at least a first portion of the end devices, generates a first global search result for the keyword according to the first local search results, and stores the first global search result in the global index database.

The disclosure includes an end device for use in a distributed network. The end device comprises a storage unit, a local index database, and a processing unit, wherein the processing unit is electrically connected to the storage unit and the local index database. The processing unit executes an operating system and an agent. The agent cooperates with a message queue service executed on a search server in the distributed network, wherein the message queue service conforms to an asynchronous communication protocol. The agent receives a keyword from the message queue service and determines that the local index database has no local search result corresponding to the keyword. The operating system derives a local search result by searching the storage unit according to the keyword and stores the local search result in the local index database. The agent returns the local search result to the message queue service.

The disclosure further includes a search method for use in a search server in a distributed network. The search server comprises a global index database and a processing unit. The processing unit executes a message queue service conforming to an asynchronous communication protocol. The search method comprises the following steps of: (a) receiving, by the message queue service, a query comprising a keyword, (b) determining, by the message queue service, that the global index database has no global search result corresponding to the keyword, (c) distributing, by the message queue service, the keyword to a plurality of end devices in the distributed network, (d) receiving, by the message queue service, a plurality of first local search results from at least a first portion of the end devices, (e) generating, by the message queue service, a first global search result for the keyword according to the first local search results, and (f) storing, by the message queue service, the first global search result in the global index database.

The disclosure additionally includes a search method for use in an end device in a distributed network. The end device comprises a storage unit, a local index database, and a processing unit. The processing unit executes an operating system and an agent. The agent cooperates with a message queue service executed on a search server in the distributed network, wherein the message queue service conforms to an asynchronous communication protocol. The search method comprises the following steps of: (a) receiving, by the agent, a keyword from the message queue service, (b) determining, by the agent, that the local index database has no local search result corresponding to the keyword, (c) deriving, by the operating system, a local search result by searching the storage unit according to the keyword, (d) storing, by the operating system, the local search result in the local index database, and (e) returning, by the agent, the local search result to the message queue service.

According to certain embodiments, a user may search documents, discover domain experts, and discover keyword trends in a distributed network. Regarding searching documents, all documents in the distributed network (i.e. all documents stored in the end devices) instead of only the documents stored in a repository database of an enterprise network are searched. When a user inputs a query comprising a keyword at the search server, the message queue service does not always have to distribute the keyword to the end devices. If the global index database has at least one global search result corresponding to the keyword, the at least one global search result will be provided to the user directly. Only when the global index database has no global search result corresponding to the keyword, the message queue service will distribute the keyword to the end devices. As a result, querying documents in the distributed network can be achieved efficiently most of the time. Moreover, since the global index database in the search server may be stored with a plurality of global search result(s) corresponding to a plurality of keywords, a user can easily discover domain experts and/or keyword trends in the distributed network.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic view of a distributed network 1 in the first and second embodiments;

FIG. 2 illustrates a schematic view of a distributed network 2 in the third embodiment;

FIG. 3 illustrates an exemplary keyword trend of a searched keyword;

FIG. 4 illustrates a flowchart of the search method of the fifth embodiment;

FIG. 5 illustrates a flowchart of the search method of the sixth embodiment;

FIG. 6 illustrates a flowchart of the search method of the seventh embodiment;

FIG. 7 illustrates a flowchart of the search method of the eighth embodiment;

FIG. 8 illustrates a flowchart of the search method of the ninth embodiment; and

FIG. 9 illustrates a flowchart of the search method of the tenth embodiment.

### DETAILED DESCRIPTION

In the following descriptions, search servers, end devices, and search methods will be explained with reference to example embodiments thereof. Nevertheless, these example embodiments are not intended to limit the present invention to any specific examples, embodiments, environments, applications, or implementations described in these example embodiments. Therefore, the description of these example embodiments is only for the purpose of illustration rather than limit the scope of the present invention. It shall be appreciated that elements not directly related to the present invention are omitted from depictions in the following embodiments and attached drawings.

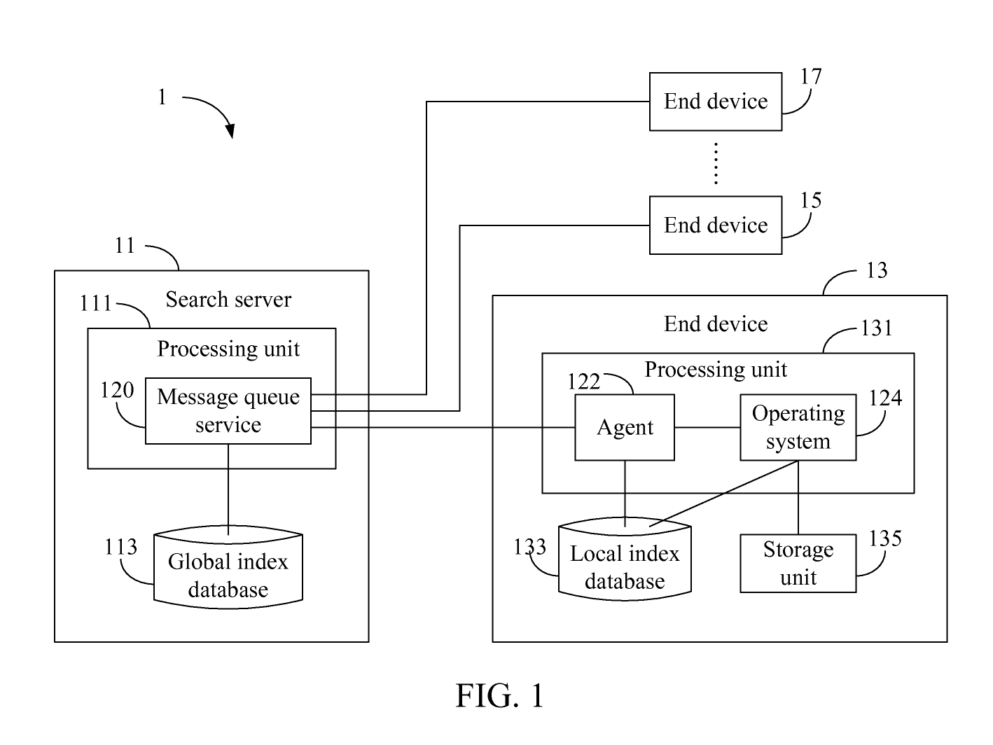

A first embodiment of the present invention is a distributed network 1 and a schematic view of which is illustrated in FIG. 1. The distributed network 1 comprises a search server 11 and a plurality of end devices 13, 15, . . . , 17. When the distributed network 1 is adopted by an enterprise, the distributed network 1 is an enterprise network and each of the end devices 13, 15, . . . , 17 may be an employee's computer. From the viewpoint of searching documents, discovering domain experts, and/or discovering trends of keywords in the distributed network 1, the end devices 13, 15, . . . , 17 operate similarly. Therefore, the following descriptions will be focused on the search server 11 and one of the end devices 13, 15, . . . , 17 (say, the end device 13).

The search server 11 comprises a processing unit 111 and a global index database 113, wherein the processing unit 111 is electrically connected to the global index database 113. The processing unit 111 may be any of various processors, central processing units (CPUs), microprocessors, or other computing devices well known to those of ordinary skill in the art. The global index database 113 may be any storage unit that can store collection of data.

The end device 13 comprises a processing unit 131, a local index database 133, and a storage unit 135, wherein the processing unit is electrically connected to the local index database 133 and the storage unit 135. The processing unit 131 may be any of various processors, central processing units, microprocessors, or other computing devices well known to those of ordinary skill in the art. The local index database 133 may be any storage unit that can store collection of data. The storage unit 135 may be a memory, a Universal Serial Bus (USB) disk, a hard disk, a compact disk (CD), a mobile disk, a magnetic tape, a database, or any other storage media or circuit with the same function and well known to those of ordinary skill in the art.

The processing unit 111 of the search server 11 executes a message queue service 120 conforming to an asynchronous communication protocol. Each of the end devices 13, 15, . . . , 17 executes an agent that cooperates with the message queue service 120 and an operating system. Taking the end device 13 as an example, the processing unit 131 executes the agent 122 and the operating system 124.

In this embodiment, a user would like to know which end device(s) in the distributed network 1 comprises documents related to a keyword. In order to get the information, the user inputs a query (not shown) comprising the keyword (not shown) through a user interface of the search server 11. The query is then transmitted to the message queue service 120. In response to receiving the query, the message queue service 120 determines whether the global index database 113 has a global search result related to the keyword. It is noted that a global search result of a keyword comprises information regarding which end device(s) comprising how many documents related to the keyword.

If the message queue service 120 determines that at least one global search result (not shown) in the global index database 113 corresponds to the keyword, the message queue service 120 provides a result of the query to the user based on the at least one global search result. The message queue service 120 may provide the at least one global search result to the user in different ways. For example, if there is only one global search result corresponding to the keyword, the message queue service 120 provides this single global search result to the user. If there are several global search results corresponding to the keyword, the message queue service 120 may provide all the global search results corresponding to the keyword to the user or provide the latest global search result to the user. Moreover, the message queue service 120 may provide the result of the query to the user via different output mechanisms, e.g. showing the result on a display, e-mailing the result to the user, etc.

If the message queue service 120 determines that the global index database 113 has no global search result corresponding to the keyword, the message queue service 120 distributes the keyword to the end devices 13, 15, . . . , 17 and waits for their responses. It is emphasized that the message queue service 120 conforms to an asynchronous communication protocol. With the characteristics of the asynchronous communication protocol, the end devices 13, 15, . . . , 17 will receive the keyword from the message queue service 120 asynchronously and will respond to the message queue service 120 asynchronously.

The end devices 13, 15, . . . , 17 operate similarly after receiving the keyword from the search server 11; hence, the following descriptions will be focused on the end device 13. The agent 122 of the end device 13 receives the keyword from the message queue service 120. In response to receiving the keyword, the agent 122 determines whether the local index database 133 has a local search result corresponding to the keyword. If there is a local search result in the local index database 133 corresponding to the keyword, the agent 122 returns the local search result to the message queue service 120. If the agent 122 determines that the local index database 133 has no local search result corresponding to the keyword, the operating system 124 searches the storage unit 135 according to the keyword and derives a local search result. In case that the end devices 13 is also connected to a cloud storage, the operating system 124 searches both the storage unit 135 and the cloud storage according to the keyword and derives a local search result. The operating system 124 stores the local search result in the local index database 135 and the agent 122 returns the local search result to the message queue service 120. It is noted that a local search result of a keyword comprises information regarding the number of documents related to the keyword in the end device 13 and even in its cloud storage (if there is one).

From the viewpoint of the search server 11, the message queue service 120 receives a plurality of local search results from at least a portion of the end devices 13, 15, . . . , 17. As mentioned, the message queue service 120 receives the local search results from at least a portion of the end devices 13, 15, . . . , 17 asynchronously. For convenience, it is assumed that the message queue service 120 receives local search results from all the end devices except the end device 17. Then, the message queue service 120 generates a global search result of the keyword according to the local search results and stores the global search result in the global index database 113. The global search result of the keyword comprises information regarding which end device(s) comprising how many documents related to the keyword. After generating the global search result for the keyword, the message queue service 120 may provide this global search result to the user. Similarly, the message queue service 120 may provide the global search result to the user via different output mechanisms.

There are some variations of the first embodiment. In some variations, each of the local search result records a document number corresponding to the keyword (i.e. the number of the documents that contains the keyword and/or the number of the documents that is related to the keyword), an author of each document, and/or a latest update date (i.e. the latest date that searching by the keyword in the end device is performed).

In some variations, when the message queue service 120 provide a global search result corresponding to the keyword to the user, some additional information may be provided to the user as well. For example, the message queue service 120 may provide a recovery rate (i.e. the number of the end devices 13, 15, . . . , 17 that has responded to the message queue service 120) and/or a latest update date of this global search result of the global search result to the user as well.

In some variations, when the message queue service 120 provides the global search result of the keyword to the user, the message queue service 120 also provides a recovery rate and/or a latest update date of this global search result to the user. After reviewing the recovery rate and/or the latest update date, the user may not be satisfied with the global search result. Under such circumstance, the user may input an update instruction (not shown) through the user interface of the search server 11. The update instruction will be received by the message queue service 120. In response to receiving the update instruction, the message queue service 120 distributes the keyword to the end devices 13, 15, . . . , 17 in order to derive latest local search results therefrom. Afterwards, the operations performed by the end devices 13, 15, . . . , 17 and the search server 11 are similar to those described in the above descriptions; hence, the details are not repeated herein.

According to the above descriptions, all documents in the distributed network 1 (i.e. all documents stored in the end devices 13, 15, . . . , 17) instead of only the documents stored in a repository database of an enterprise network can be queried by a user. When a user inputs a query comprising a keyword at the search server 11, the message queue service 120 does not always have to distribute the keyword to the end devices 13, 15, . . . , 17. If the global index database 113 has at least one global search result corresponding to the keyword, the at least one global search result will be provided to the user directly. Only when the global index database 113 has no global search result corresponding to the keyword, the message queue service 120 will distribute the keyword to the end devices 13, 15, . . . , 17. As a result, querying documents in the distributed network 1 can be achieved efficiently most of the time.

Please also refer to FIG. 1 for a second embodiment of the present invention. The following descriptions will be focused on the differences between this embodiment and the first embodiment.

In this embodiment, a user would like to know which end device(s) in the distributed network 1 comprises documents related to a keyword. In order to get the information, the user inputs a query (not shown) comprising the keyword (not shown) from any of the end devices 13, 15, . . . , 17. For convenience, it is assumed that the end device 13 is the concerned one.

To be more specific, the user inputs a query (not shown) comprising a keyword (not shown) through a user interface of the end device 13. The query will be transmitted to the agent 122. In response to receiving the query, the agent 122 publishes the keyword to the message queue service 120. After receiving the query from the agent 122, the message queue service 120 distributes the keyword to the end devices 13, 15, . . . , 17 and waits for their response.

Afterwards, the operations performed by the end devices 13, 15, . . . , 17 and the search server 11 are similar to those described in the first embodiments. Briefly speaking, for an end device, if its local index database has a local search result corresponding to the keyword, the end device simply returns the local search result to the message queue service 120. For an end device, if its local index database has no local search result corresponding to the keyword, the end device derives a local search result of the keyword by searching its storage unit (or additionally a cloud storage) according to the keyword and returns the local search result to the message queue service 120.

Later on, the user may check a result of the query from the search server 11. Briefly speaking, the result of the query is a global search result comprising the aforementioned local search results from at least a portion of the end devices 13, 15, . . . , 17. Similar to the first embodiment, a global search result of a keyword comprises information regarding which end device(s) comprising how many documents related to the keyword.

In addition to the aforesaid operations, the second embodiment can also execute all the operations and have all functionalities set forth in the first embodiment. The second embodiment executing these operations and having these functionalities will be readily appreciated by those of ordinary skill in the art based on the descriptions of the first embodiment. Therefore, the details will not be further described herein. In addition, the second embodiment may have various variations as well and the variations are similar to those described in the first embodiment. Hence, the details will not be further described herein.

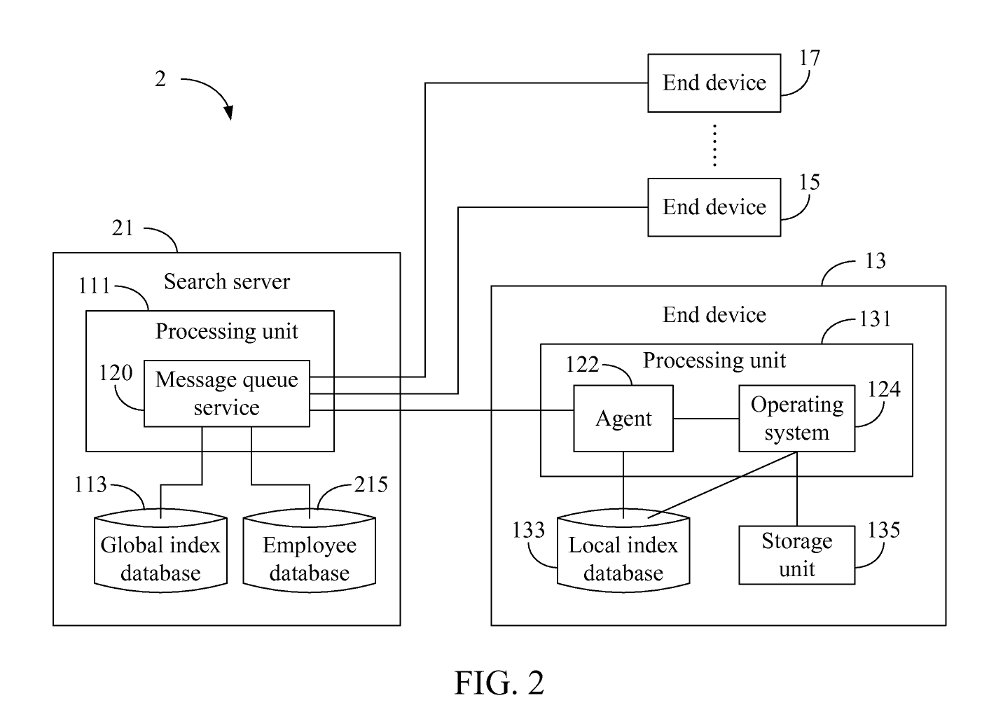

A third embodiment of the present invention is a distributed network 2 and a schematic view of which is illustrated in FIG. 2. The distributed network 2 comprises a search server 21 and a plurality of end devices 13, 15, . . . , 17. When the distributed network 2 is adopted by an enterprise, the distributed network 2 is an enterprise network and each of the end devices 13, 15, . . . , 17 may be an employee's computer.

The end devices 13, 15, . . . , 17 are similar to those described in the first and second embodiments. The search server 21 comprises a processing unit 111, a global index database 113, and an employee database 215, wherein the processing unit 111 is electrically connected to the global index database 113 and the employee database 215. It is noted that the processing unit 111 and the global index database 113 of the search server 21 are similar to those described in the first and second embodiments and the employee database 215 may be any storage unit that can store collection of data. In some variations of the third embodiment, the employee database 215 may be external to the search server 21 instead of being comprised in the search server 21. In this embodiment, each of the end devices 13, 15, . . . , 17 corresponds to a user. When the distributed network 2 is adopted by an enterprise, each of the end devices 13, 15, . . . , 17 corresponds to an employee in the enterprise. The employee database 215 is stored with the correspondences between users and the end devices 13, 15, . . . , 17.

The third embodiment is based on the first embodiment and/or the second embodiment. To be more specific, one or more users have queried the distributed network 2 by a keyword for at least one time, which means that the global index database 113 is stored with at least one global search result of the keyword.

In this embodiment, a user would like to discover domain experts from the distributed network 2. In order to get the information, the user inputs a domain expert query (not shown) comprising the keyword through a user interface of the search server 21. The domain expert query is then transmitted to the message queue service 120. In response to receiving the domain expert query, the message queue service 120 retrieves a global search result corresponding to the keyword from the global index database 113. In case that there are more than one global search result corresponding to the keyword, the message queue service 120 may retrieve the latest one. Like those described in the first and second embodiments, the global search result retrieved by the message queue service 120 comprises a plurality of local search results and each of the local search result is from one of the end devices 13, 15, . . . , 17. It is noted that since each of the local search result is from one of the end devices 13, 15, . . . , 17 and each of the end devices 13, 15, . . . , 17 corresponds to a user, each of the local search result corresponds to a user.

The message queue service 120 calculates a weight for each of the local search results. For example, for the local search result of the end device 13, the message queue service 120 may calculate a weight for the local search result according to a document number corresponding to the keyword (i.e. the number of the documents that contains the keyword in the end device 13 and/or the number of the documents that is related to the keyword in the end device 13), an author of each document, and/or a latest update date of each document. In this example, for the rest local search result(s), the message queue service 120 calculates their weights by the same approach.

As mentioned, each of the local search result is from one of the end devices 13, 15, . . . , 17 and the employee database 215 is stored with the correspondences between users and the end devices 13, 15, . . . , 17; hence, the message queue service 120 is able to identify that which local search result corresponds to which user. Then, the message queue service 120 calculates a grade for each of the users according to the weight of the corresponding local search result. For example, for each user, the message queue service 120 may simply adopts the weight of the corresponding local search result as the grade of the user. Yet in another example, for each user, the message queue service 120 may calculates the grade according to an indication corresponding to the salary of the user and the weight of the corresponding local search result, and it is useful for an enterprise to discover specific domain experts to form a new project team with budget constraint. Afterwards, the message queue service 120 may further sort the users according to the grades and provides the sorted result to the user. It is noted that the message queue service 120 may provide the sorted result to the user via different output mechanisms, e.g. showing the sored result on a display, e-mailing the sorted result to the user, etc. Therefore, the user who inputted the domain expert query learns the domain experts from the distributed network 2.

In addition to the aforesaid operations, the third embodiment can also execute all the operations and have all functionalities set forth in the first and second embodiments. The third embodiment executing these operations and having these functionalities will be readily appreciated by those of ordinary skill in the art based on the descriptions of the first and second embodiments. Therefore, the details will not be further described herein. In addition, the third embodiment may have various variations as well and the variations are similar to those described in the first and second embodiments. Hence, the details will not be further described herein.

According to the above descriptions, with the global search result(s) in the global index database 113, a user can query domain experts in the distributed network 2 by simply using a keyword.

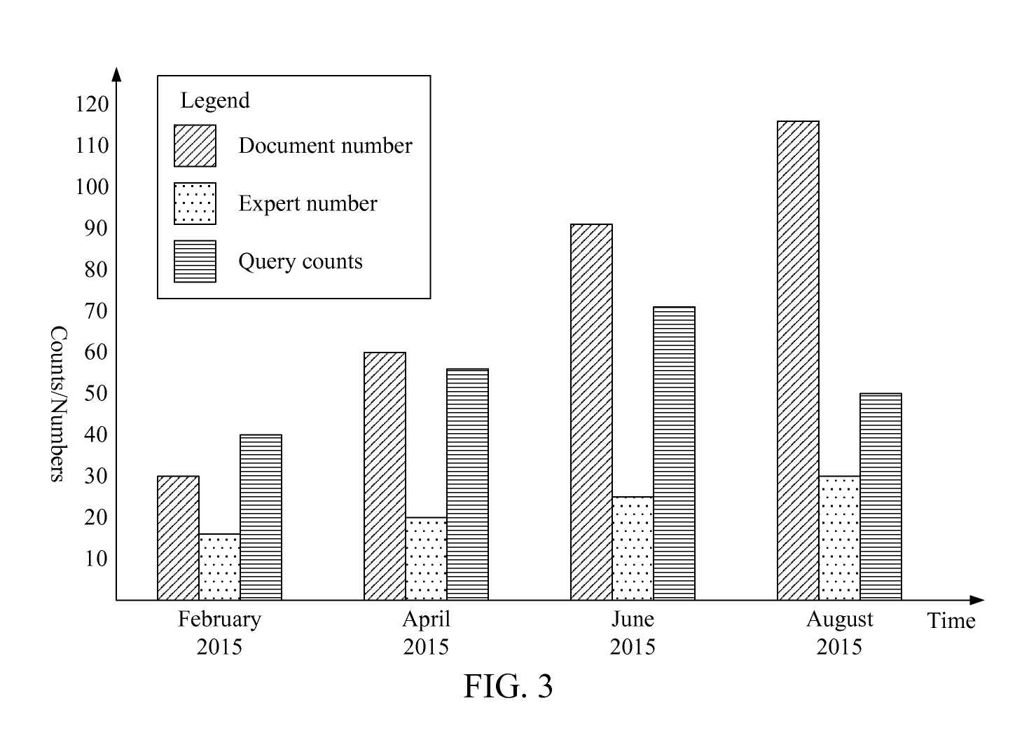

Please refer to FIG. 1, FIG. 2, and FIG. 3 for a fourth embodiment of the present invention. The fourth embodiment is based on the first embodiment, the second embodiment, and/or the third embodiment. To be more specific, one or more users have queried the distributed network 1 (in the first embodiment and/or second embodiment) and/or the distributed network 2 (in the third embodiment) by a plurality of keywords, which means that the global index database 113 is stored with a plurality of existed global search results (not shown) and each of the existed global search results corresponds to a searched keyword.

In this embodiment, a user would like to discover the trend of the keyword(s) in the distributed network 1 (in the first embodiment and/or second embodiment) and/or the distributed network 2 (in the third embodiment). In order to get the information, the user inputs a keyword trend query (not shown) through the user interface of the search server 11 (in the first embodiment and/or the second embodiment) and/or the search server 21 (in the third embodiment). The keyword trend query is then transmitted to the message queue service 120. In response to receiving the keyword trend query, the message queue service 120 determines whether the global index database has a keyword trend result. It is noted that the keyword trend result(s) may be stored in other database or storage unit in some variations of the fourth embodiment.

If the message queue service 120 determines that there is at least one keyword trend result in the global index database 113, the message queue service 120 provides a result of the keyword trend query to the user based on the at least one keyword trend result. The message queue service 120 may provide the at least one keyword trend result to the user in different ways. For example, if there is only one keyword trend result, the message queue service 120 provides this single keyword trend result to the user. If there are several keyword trend results, the message queue service 120 may provide all the keyword trend results to the user or provide the latest keyword trend result to the user. Moreover, the message queue service 120 may provide the keyword trend result(s) to the user via different output mechanisms, e.g. showing the keyword trend result(s) on a display, e-mailing the keyword trend result(s) to the user, etc.

If the message queue service 120 determines that there is no keyword trend result in the global index database 113, the message queue service 120 creates a new keyword trend result. Particularly, the message queue service 120 calculates a statistic number for each of the searched keywords according to the existed global search results (i.e. calculates a query count for each of the searched keywords). The message queue service 120 also creates a keyword trend for each of the searched keywords. A keyword trend of a searched keyword may comprise a document count, an expert number (only when based on the third embodiment), a query count, and/or other information in various period of time. FIG. 3 illustrates an exemplary keyword trend of a searched keyword and which is not used to limit the scope of the present invention. Next, the message queue service 120 sorts the searched keywords according to the statistic numbers. The new keyword trend result comprises the sorted searched keywords and the keyword trend of each of the searched keywords. Then, the message queue service 120 provides the new keyword trend result to the user. If the user further selects any of the searched keyword, the message queue service 120 provides the keyword trend of the selected searched keyword to the user.

In some variations of the fourth embodiment, the user may not be satisfied with the result of the keyword trend query (e.g. the user may doubt that the result is not new enough) after reviewing the keyword trend result. Under such circumstance, the user may input an update instruction (not shown) through the user interface of the search server 11 (in the first embodiment and/or the second embodiment) or the search server 21 (in the third embodiment), which will be received by the message queue service 120. In response to receiving the update instruction, the message queue service 120 generates a new keyword trend result again according to the operations described above.

In addition to the aforesaid operations, the fourth embodiment can also execute all the operations and have all functionalities set forth in the first, second, and third embodiments. The fourth embodiment executing these operations and having these functionalities will be readily appreciated by those of ordinary skill in the art based on the descriptions of the first, second, and third embodiments. Therefore, the details will not be further described herein. In addition, the fourth embodiment may have various variations as well and the variations are similar to those described in the first, second, and third embodiments. Hence, the details will not be further described herein.

According to the above descriptions, with the exited global search result(s) in the global index database 113, a user can discover the trends of keywords in the distributed network 1 (in the first embodiment and/or the second embodiment) and/or the distributed network 2 (in the third embodiment).

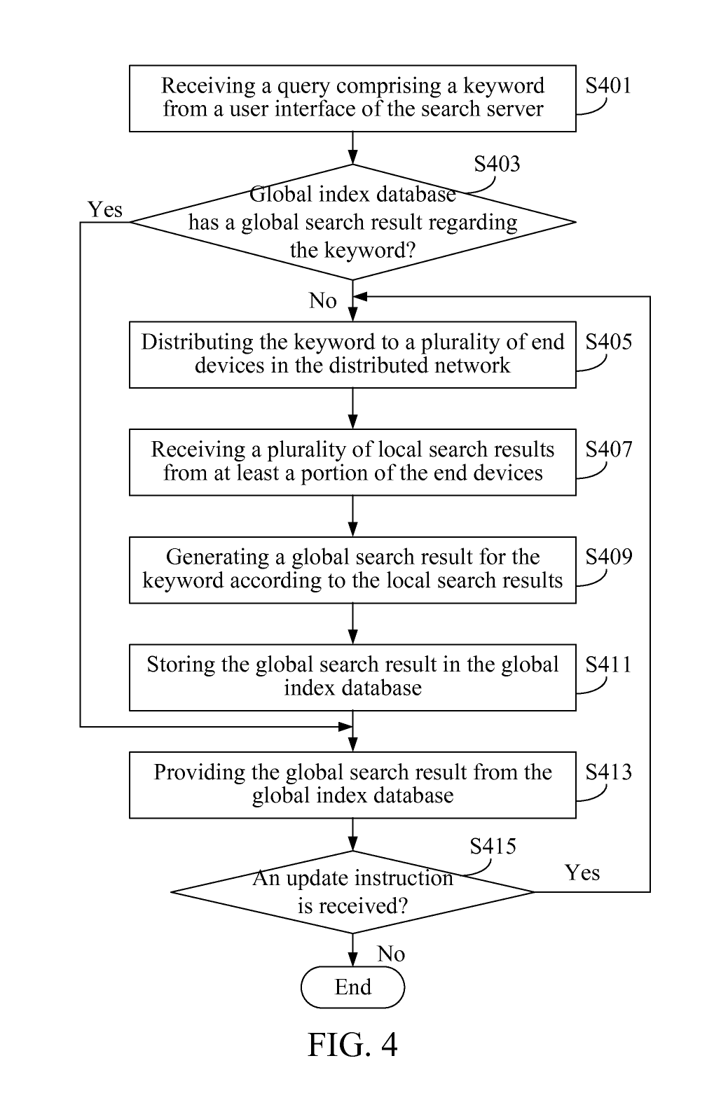

A fifth embodiment of the present invention is a search method for use in a search server (e.g. the search server 11 in the first embodiment) of a distributed network and a flowchart of which is illustrated in FIG. 4. The search server comprises a global index database and a processing unit, wherein the processing unit executes a message queue service conforming to an asynchronous communication protocol.

First, step S401 is executed by the message queue service for receiving a query comprising a keyword from a user interface of the search server. Next, step S403 is executed by the message queue service for determining whether the global index database has a global search result corresponding to the keyword. If the step S403 determines that the global index database has no global search result corresponding to the keyword, step S405 is then executed by the message queue service for distributing the keyword to a plurality of end devices in the distributed network. Following that, step S407 is executed by the message queue service for receiving a plurality of local search results corresponding to the keyword from at least a portion of the end devices. It is noted that each of the local search results may record one of a document number, a latest update date, at least one author, and a combination thereof. Next, step S409 is executed by the message queue service for generating a global search result for the keyword according to the local search results. Following that, step S411 is executed by the message queue service for storing the global search result in the global index database. In step S413, the message queue service provides the global search result from the global index database to the user. It is noted that if the step S403 determines that the global index database has global search result corresponding to the keyword, the search method directly executes S413.

Following that, step S415 is executed by the message queue service for determining whether an update instruction is received. If the step S415 determines no update instruction is received, the search method is ended. If the step S415 determines that an update instruction is received, then the search method proceeds to the step S405. It is noted that in some variations of this embodiment, the step S415 can be omitted.

In addition to the aforesaid steps, the fifth embodiment can also execute all the operations and have all functionalities of the search server set forth in the first embodiment. The fifth embodiment executing these operations and having these functionalities will be readily appreciated by those of ordinary skill in the art based on the explanation of the first embodiment, and thus will not be further described herein.

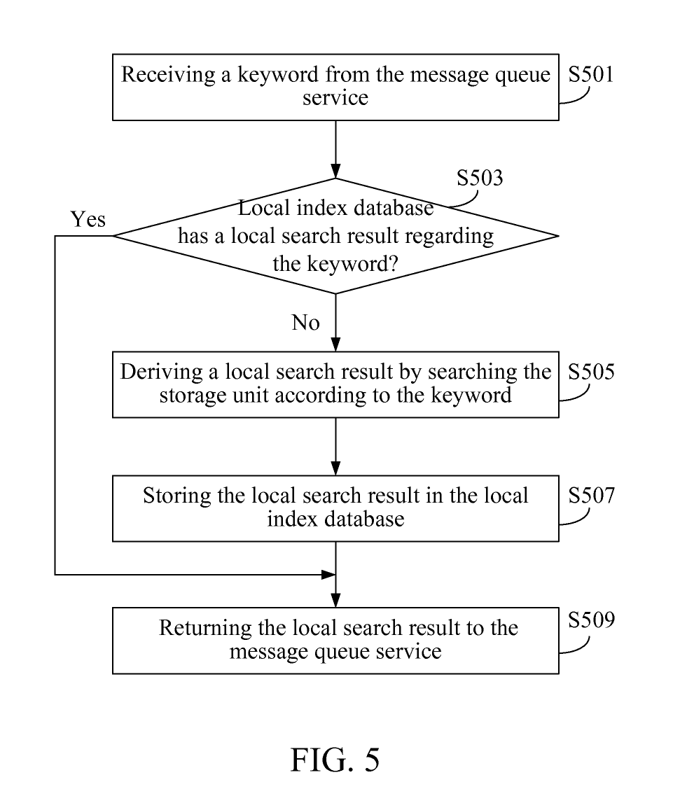

A sixth embodiment of the present invention is a search method for use in an end device (e.g. the end device 13 in the first embodiment) of a distributed network and a flowchart of which is illustrated in FIG. 5. The end device comprises a storage unit, a local index database, and a processing unit. The processing unit executes an operating system and an agent. The agent cooperates with a message queue service executed on a search server in the distributed network. The message queue service conforms to an asynchronous communication protocol. The search method in this embodiment may cooperate with the search method described in the fifth embodiment.

First, step S501 is executed by the agent for receiving a keyword from the message queue service. Next, step S503 is executed by the agent for determining whether the local index database has a local search result corresponding to the keyword. Here, a local index database has a local search result means that the local index database has a local search result which last update time is later than a predefined time threshold. In other words, if a local index database has no local search result corresponding to the keyword or if a local index database has a not up-to-date enough local search result, the local index database will then be determined as having no local search result. It is noted that a local search result may record one of a document number, a latest update date, at least one author, and a combination thereof. If the step S503 determines that the local index database has no local search result corresponding to the keyword, step S505 is executed by the operating system for deriving a local search result by searching the storage unit according to the keyword. Following that, step S507 is executed by the operating system for storing the local search result in the local index database. Step S509 is executed by the agent for returning the local search result to the message queue service. If step S503 determines that the local index database has a local search result corresponding to the keyword, the search method proceeds to the step S509.

In addition to the aforesaid steps, the sixth embodiment can also execute all the operations and have all functionalities of the end device set forth in the first embodiment. The sixth embodiment executing these operations and having these functionalities will be readily appreciated by those of ordinary skill in the art based on the explanation of the first embodiment, and thus will not be further described herein.

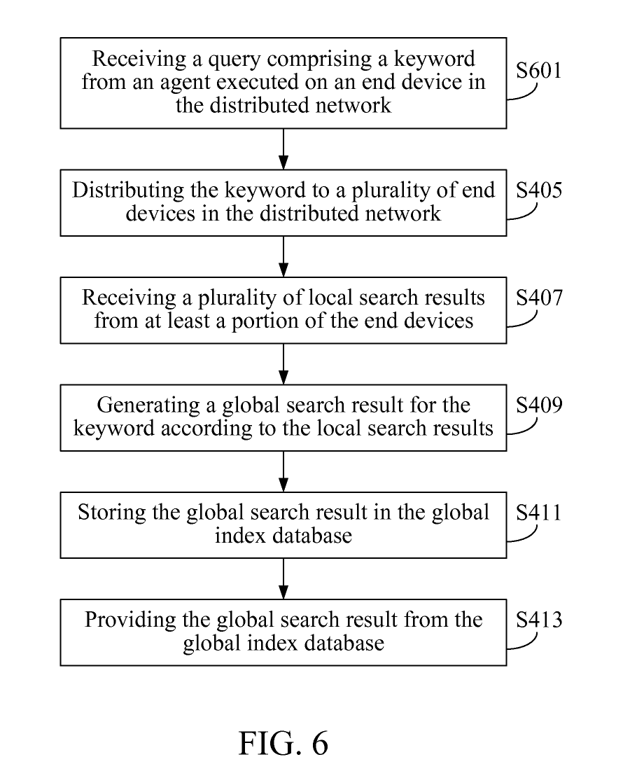

A seventh embodiment of the present invention is a search method for use in a search server (e.g. the search server 11 in the second embodiment) of a distributed network and a flowchart of which is illustrated in FIG. 6. The search server comprises a global index database and a processing unit, wherein the processing unit executes a message queue service conforming to an asynchronous communication protocol.

First, step S601 is executed by the message queue service for receiving a query comprising a keyword from an agent executed on an end device in the distributed network. Afterwards, the search method executes the steps S405, S407, S409, S411, and S413 in sequence. It is noted that the steps S405, S407, S409, S411, and S413 are the same as those described in the fifth embodiment; hence, the descriptions are not repeated herein.

In addition to the aforesaid steps, the seventh embodiment can also execute all the operations and have all functionalities of the search server set forth in the second embodiment. The seventh embodiment executing these operations and having these functionalities will be readily appreciated by those of ordinary skill in the art based on the explanation of the second embodiment, and thus will not be further described herein.

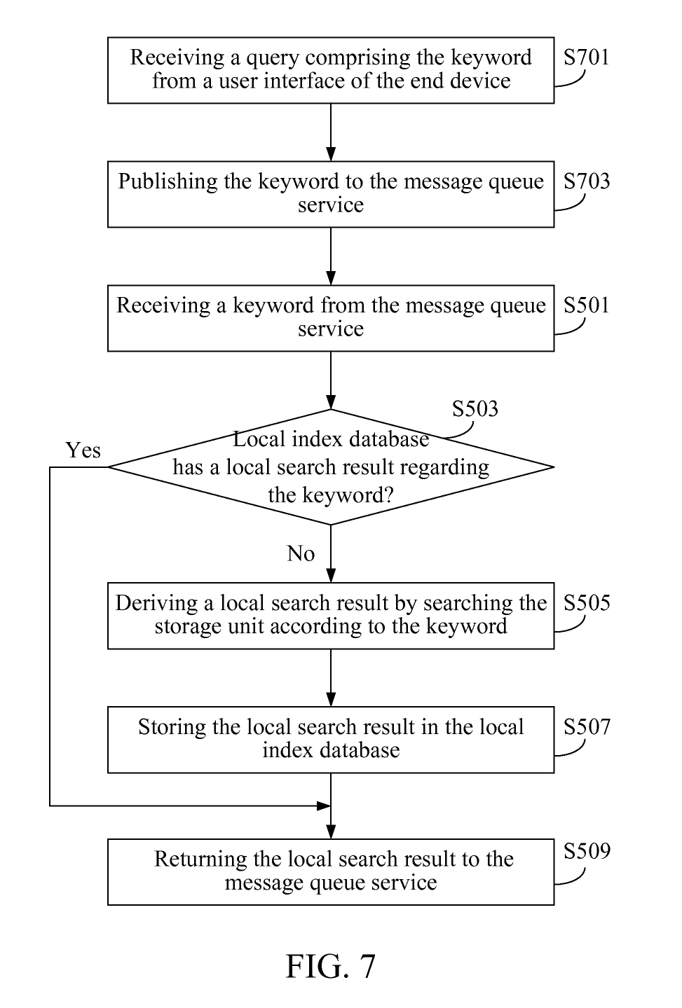

An eighth embodiment of the present invention is a search method for use in an end device (e.g. the end device 13 in the second embodiment) of a distributed network and a flowchart of which is illustrated in FIG. 7. The end device comprises a storage unit, a local index database, and a processing unit. The processing unit executes an operating system and an agent. The agent cooperates with a message queue service executed on a search server in the distributed network. The message queue service conforms to an asynchronous communication protocol. The search method in this embodiment may cooperate with the search method described in the seventh embodiment.

First, step S701 is executed by the agent for receiving a query comprising the keyword from a user interface of the end device. Next, step S703 is executed by the agent for publishing the keyword to the message queue service. Afterwards, the search method executes the steps S501, S503, S505, S507, and S509 in sequence. It is noted that the steps S501, S503, S505, S507, and S509 are the same as those described in the sixth embodiment; hence, the descriptions are not repeated herein.

In addition to the aforesaid steps, the eighth embodiment can also execute all the operations and have all functionalities of the end device set forth in the second embodiment. The eighth embodiment executing these operations and having these functionalities will be readily appreciated by those of ordinary skill in the art based on the explanation of the second embodiment, and thus will not be further described herein.

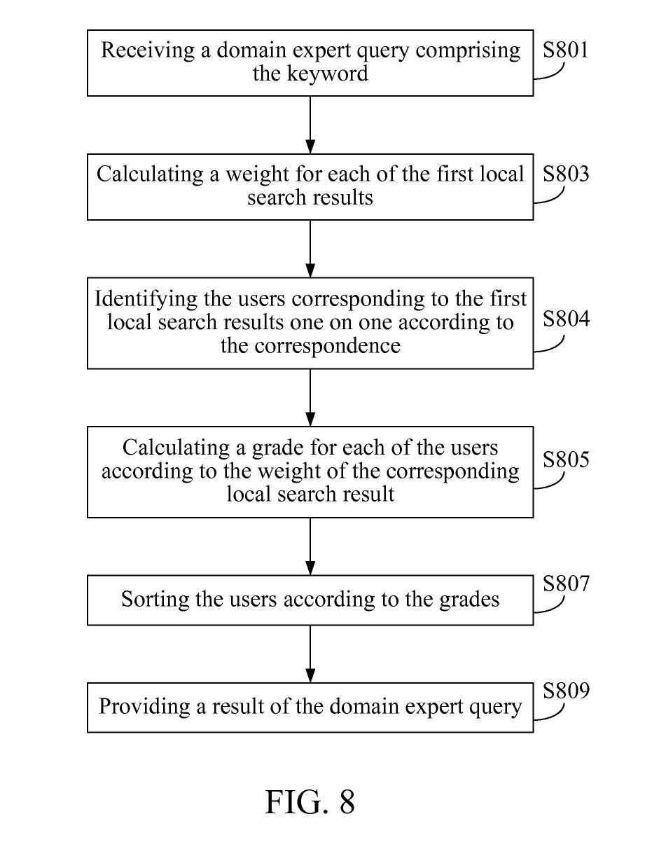

A ninth embodiment of the present invention is a search method for use in a search server (e.g. the search server 21 in the third embodiment) of a distributed network and a flowchart of which is illustrated in FIG. 8. The search server comprises a global index database, a processing unit, and an employee database. The processing unit executes a message queue service conforming to an asynchronous communication protocol. The employee database is stored with a correspondence between a plurality of users and the end devices.

In this embodiment, one or more users have queried the distributed network by a keyword for at least one time, which means that the global index database is stored with at least one global search result of the keyword. The search method in this embodiment can discover domain experts from the distributed network.

First, step S801 is executed by the message queue service for receiving a domain expert query comprising the keyword. Next, step S803 is executed by the message queue service for calculating a weight for each of the local search results. It is noted that each of the local search results corresponds to a user. After that, step S804 is executed by the message queue service for identifying the users corresponding to the first local search results one on one according to the correspondence stored in the employee database. Following that, step S805 is executed by the message queue service for calculating a grade for each of the users according to the weight of the corresponding local search result. Next, step S807 is executed by the message queue service for sorting the users according to the grades. Afterwards, step S809 is executed by the message queue service for providing a result of the domain expert query, which comprises a list of the sorted users.

In addition to the aforesaid steps, the ninth embodiment can also execute all the operations and have all functionalities of the search server set forth in the third embodiment. The ninth embodiment executing these operations and having these functionalities will be readily appreciated by those of ordinary skill in the art based on the explanation of the third embodiment, and thus will not be further described herein.

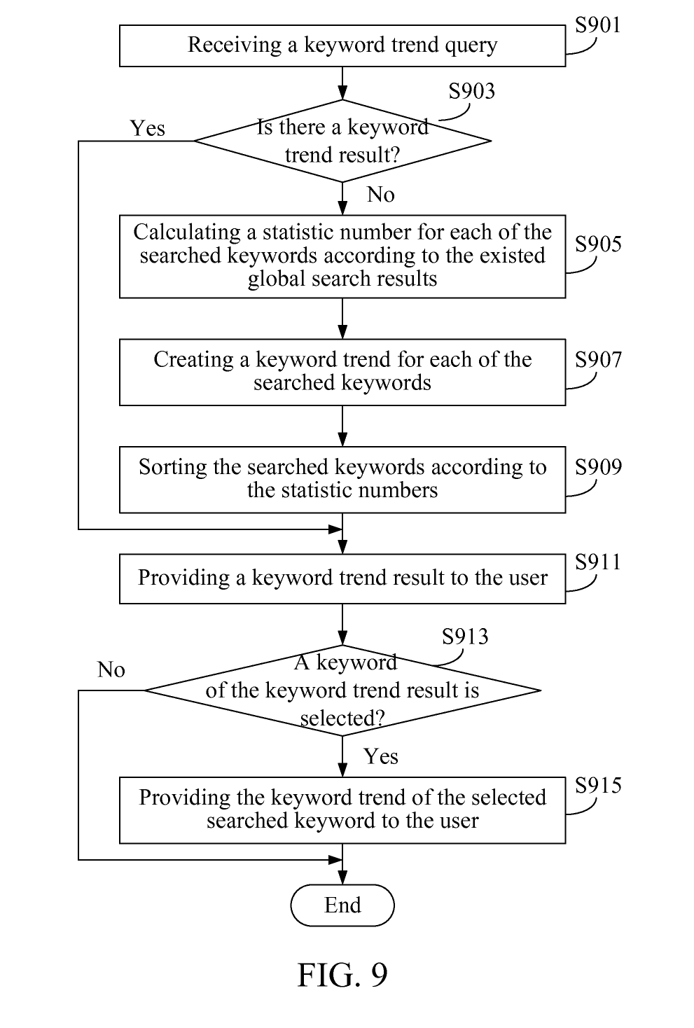

A tenth embodiment of the present invention is a search method for use in a search server (e.g. the search server 21 in the third embodiment) of a distributed network and a flowchart of which is illustrated in FIG. 9. The search server comprises a global index database, a processing unit, and an employee database. The processing unit executes a message queue service conforming to an asynchronous communication protocol. The employee database is stored with a correspondence between a plurality of users and the end devices.

In this embodiment, one or more users have queried the distributed network by a plurality of keywords, which means that the global index database is stored with a plurality of existed global search results (not shown) and each of the existed global search results corresponds to a searched keyword. The search method in this embodiment can discover the trend of keyword(s) in the distributed network.

First, step S901 is executed by the message queue service for receiving a keyword trend query. Next, step S903 is executed by the message queue service for determining whether there is a keyword trend result in the global index database or other databases. If the step S903 determines that there is no keyword trend result, step S905 is then executed by the message queue service for calculating a statistic number for each of the searched keywords according to the existed global search results. Next, step S907 is executed by the message queue service for creating a keyword trend for each of the searched keywords. A keyword trend of a searched keyword may comprise a document count, an expert number, a query count, and/or other information in various period of time. Following that, step S909 is executed by the message queue service for sorting the searched keywords according to the statistic numbers. Afterwards, step S911 is executed by the message queue service for providing a keyword trend result to the user. It is noted that the keyword trend result comprises the sorted searched keywords and the keyword trend of each of the searched keywords. If the step S903 determines that there is a keyword trend result, the search method proceeds to the step S911 directly.

After the step S911, step S913 is executed by the message queue service for determining whether a keyword of the keyword trend result is selected by the user. If the answer of the step S913 is yes, step S915 is executed by the message queue service for providing the keyword trend of the selected searched keyword to the user. After the step S915, the search method terminates. If the step S913 determines that no keyword of the keyword trend result is selected by the user, the search method terminates.

In addition to the aforesaid steps, the tenth embodiment can also execute all the operations and have all functionalities of the search server set forth in the fourth embodiment. The tenth embodiment executing these operations and having these functionalities will be readily appreciated by those of ordinary skill in the art based on the explanation of the fourth embodiment, and thus will not be further described herein.

According to the above embodiments, a user may search documents, discover domain experts, and discover keyword trends in a distributed network. Regarding searching documents, all documents in the distributed network (i.e. all documents stored in the end devices) instead of only the documents stored in a repository database of an enterprise network are searched. When a user inputs a query comprising a keyword at the search server, the message queue service does not always have to distribute the keyword to the end devices. If the global index database has at least one global search result corresponding to the keyword, the at least one global search result will be provided to the user directly. Only when the global index database has no global search result corresponding to the keyword will the message queue service distribute the keyword to the end devices. As a result, querying documents in the distributed network can be achieved efficiently most of the time. Moreover, since the global index database in the search server may be stored with a plurality of global search result(s) corresponding to a plurality of keywords, a user can easily discover domain experts and/or keyword trends in the distributed network.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A search server for use in a distributed network, comprising:
a global index database; and
a processing unit, being electrically connected to the global index database and configured to execute a message queue service conforming to an asynchronous communication protocol;
wherein the message queue service receives a first query comprising a keyword, determines that the global index database has no global search result corresponding to the keyword, distributes the keyword to a plurality of end devices in the distributed network, receives a plurality of first local search results from at least a first portion of the end devices, generates a first global search result for the keyword according to the first local search results, and stores the first global search result in the global index database.

2. The search server of claim 1, wherein the message queue service receives a second query comprising the keyword, determines that the first global search result in the global index database corresponds to the keyword, and provides the first global search result from the global index database.

3. The search server of claim 2, wherein the message queue service further receives an update instruction after providing the first global search result of the keyword, distributes the keyword to the end devices, receives a plurality of second local search results from at least a second portion of the end devices, generates a second global search result for the keyword according to the second local search results, and stores the second global search result in the global index database.

4. The search server of claim 1, wherein each of the first local search results records one of a document number, a latest update date, at least one author, and a combination thereof.

5. The search server of claim 1, further comprising:
an employee database, being stored with a correspondence between a plurality of users and the end devices;
wherein the message queue service identifies the users corresponding to the first local search results one on one according to the correspondence, the message queue service further receives a domain expert query comprising the keyword, calculates a weight for each of the first local search results, calculates a grade for each of the users according to the weight of the corresponding first local search result, and sorting the users according to the grades.

6. The search server of claim 1, wherein the global index database is stored with a plurality of existed global search results, each of the existed global search results corresponds to a searched keyword, and the message queue service further receives a keyword trend query, calculates a statistic number for each of the searched keywords according to the existed global search results, creates a keyword trend for each of the searched keywords, and sorts the searched keywords according to the statistic numbers.

7. An end device for use in a distributed network, comprising:
a storage unit;
a local index database; and
a processing unit, being electrically connected to the storage unit and the local index database and configured to execute an operating system and an agent, wherein the agent cooperates with a message queue service executed on a search server in the distributed network and the message queue service conforms to an asynchronous communication protocol;
wherein the agent receives a keyword from the message queue service, the agent determines that the local index database has no local search result corresponding to the keyword, the operating system derives a local search result by searching the storage unit according to the keyword and stores the local search result in the local index database, and the agent returns the local search result to the message queue service.

8. The end device of claim 7, wherein the agent further receives the keyword from the message queue service, determines that the local search result in the local index database corresponds to the keyword, and returns the local search result to the message queue service.

9. The end device of claim 7, wherein the local search results records one of a document number, a latest update date, at least one author, and a combination thereof.

10. The end device of claim 7, wherein the agent receives a query comprising the keyword and publishes the keyword to the message queue service.

11. A search method for use in a search server in a distributed network, the search server comprising a global index database and a processing unit, the processing unit executing a message queue service conforming to an asynchronous communication protocol, the search method comprising:
receiving, by the message queue service, a first query comprising a keyword;
determining, by the message queue service, that the global index database has no global search result corresponding to the keyword;
distributing, by the message queue service, the keyword to a plurality of end devices in the distributed network;
receiving, by the message queue service, a plurality of first local search results from at least a first portion of the end devices;
generating, by the message queue service, a first global search result for the keyword according to the first local search results; and
storing, by the message queue service, the first global search result in the global index database.

12. The search method of claim 11, further comprising:
receiving, by the message queue service, a second query comprising the keyword;
determining, by the message queue service, that the first global search result in the global index database corresponds to the keyword; and
providing, by the message queue service, the first global search result from the global index database.

13. The search method of claim 12, further comprising:
receiving, by the message queue service, an update instruction after providing the first global search result of the keyword;
distributing, by the message queue service, the keyword to the end devices;
receiving, by the message queue service, a plurality of second local search results from at least a second portion of the end devices;
generating, by the message queue service, a second global search result for the keyword according to the second local search results; and
storing, by the message queue service, the second global search result in the global index database.

14. The search method of claim 11, wherein each of the first local search results records one of a document number, a latest update date, at least one author, and a combination thereof.

15. The search method of claim 11, wherein the search server further comprises an employee database, the employee database is stored with a correspondence between a plurality of users and the end devices, and the search method further comprises:
receiving, by the message queue service, a domain expert query comprising the keyword;
calculating, by the message queue service, a weight for each of the first local search results;
identifying, by the message queue service, the users corresponding to the first local search results one on one according to the correspondence;
calculating, by the message queue service, a grade for each of the users according to the weight of the corresponding first local search result; and
sorting, by the message queue service, the users according to the grades.

16. The search method of claim 11, wherein the global index database is stored with a plurality of existed global search results, each of the existed global search results corresponds to a searched keyword, and the search method further comprises:
receiving, by the message queue service, a keyword trend query;
calculating, by the message queue service, a statistic number for each of the searched keywords according to the existed global search results;
creating, by the message queue service, a keyword trend for each of the searched keywords; and
sorting, by the message queue service, the searched keywords according to the statistic numbers.

17. A search method for use in an end device in a distributed network, the end device comprising a storage unit, a local index database, and a processing unit, the processing unit executing an operating system and an agent, the agent cooperating with a message queue service executed on a search server in the distributed network, the message queue service conforming to an asynchronous communication protocol, and the search method comprising:
receiving, by the agent, a keyword from the message queue service;
determining, by the agent, that the local index database has no local search result corresponding to the keyword;
deriving, by the operating system, a local search result by searching the storage unit according to the keyword;
storing, by the operating system, the local search result in the local index database; and
returning, by the agent, the local search result to the message queue service.

18. The search method of claim 17, further comprising:
receiving, by the agent, the keyword from the message queue service;
determining, by the agent, that the local search result in the local index database corresponds to the keyword; and
returning, by the agent, the local search result to the message queue service.

19. The search method of claim 17, wherein the local search results records one of a document number, a latest update date, at least one author, and a combination thereof.

20. The search method of claim 17, further comprising:
receiving, by the agent, a query comprising the keyword; and
publishing, by the agent, the keyword to the message queue service.
